(19) United States
(12) Patent Application Publication
(10) Pub. No.: US 2009/0186196 A1
(43) Pub. Date: Jul. 23, 2009

(54) Multistable Structural Member and Method for Forming a Multistable Structural Member

(75) Inventors: Keith A. Seffen, Cambridgeshire (GB); Simon David Guest, Cambridgeshire (GB); Alexander David Norman, Cambridgeshire (GB); William Mulholland, Dumfries (GB)

Correspondence Address: Leason Ellis LLP, 81 Main Street, Suite 503, White Plains, NY, 10601, US

(73) Assignee: Cambridge Enterprise Limited, Cambridgeshire (GB)

(21) Appl. No.: 12/306,219

(22) PCT Filed: Jun. 22, 2007
(86) PCT No.: PCT/GB2007/002351

§ 371 Date: Dec. 22, 2008

(30) Foreign Application Priority Data
Jun. 23, 2006 (GB) 0612558.7

(51) Int. Cl. B32B 3/28; B29C 53/24

(52) U.S. Cl. 428/182; 264/284

(57) ABSTRACT

Disclosed is a multistable structural member (10), of use in various structural applications. The member (10) has a sheet form. In a first configuration (e.g. open configuration), a first distribution of stored elastic stresses is counterbalanced against at least two reinforcing corrugations (12). In a second configuration (e.g. rolled configuration), these corrugations (12) are deformed to provide a second, different distribution of stored elastic stresses counterbalanced by the shape of the member in the second configuration. The first and second configurations are stable but reversibly interchangeable. An external force is required to cause a transformation between the first and second configurations. The member may be formed by suitable plastic deformation of a metallic sheet. A method for forming such a multistable structural member (10), a multistable structure an a multistable assembly (3), having a plurality of multistable members are also disclosed.

The present invention relates to a multistable structural member and a method for forming the same. Particularly, but not exclusively, the invention is concerned with bistable structural members, especially those for which one stable configuration is a planar configuration.

WO 97/35706 discloses an elongate member that can be configured between two states. The first state is a coil in which the member is coiled so that it defines a coil axis. The second state is an extended state in which the member extends as a tubular structure along an axis perpendicular to the coil axis. When extended from the first state, the member spontaneously takes up the second state. The elongate member in this document is a fibre-reinforced composite, the special bistable properties of the member being provided by the location and orientation of the fibres in the composite matrix, and the difference in elastic modulus between the fibres and the matrix.

WO 99/62811 discloses a development of the technology of WO 97/35706, in which two or three coilable members are provided that in the extended state adopt an arcuate (but not tubular) cross sectional shape. The coilable members are joined at their edges so that together they provide a structural support for a load. Similarly to WO 97/35706, the members are formed from fibre-reinforced composite material.

WO 99/62812 discloses a further development of the technology of WO 97/35706, in which the member has one or more resilient protruding fins on a surface, said fins adopting one configuration when the member is in the coiled state and another configuration when the member is in the extended state. The fins deform when the member is configured between the extended state and the coiled state, in order to allow the coiling to be relatively tight. However, the fins do not themselves provide the impetus for configuring the member into either state.

U.S. Pat. No. 5,628,069 discloses a glove having a bistable spring element provided in order to assist with flexing of the digits of the glove. The spring element is elongate (of the order of dimensions of a human finger) and has a first (closed) state in which it has an arcuate shape in the elongate direction and substantially straight in the transverse direction, and a second state in which it is straight in the elongate direction and arcuate in the transverse direction. The spring element has two creases formed in the elongate direction, these creases stabilising the element in the second state against reconfiguring to the first state in the absence of external influence.

Shape memory alloys are known that can be formed into a structure so as to be reversibly configurable between two different shapes, typically due to a change in temperature. Such materials typically rely on crystallographic martensitic phase transformations to accommodate the shape change without permanent, non-recoverable deformation. However, such materials are extremely limited in their temperature operation range and the effect is only seen for very particular alloy compositions and is typically triggered by a temperature change. Furthermore, the incorporation of a “memorised” shape for a shape memory alloy device requires complex and repeated mechanical working.

K. Seffen, in “Bi-stable concepts for reconfigurable structures” (45th AIAA Structures, Structural Dynamics and Materials Conference, Palm Springs, Calif., 19-22 Apr. 2004, No. 2004-1526, the content of which is hereby incorporated by reference in its entirety) discusses the structure of bistable metallic structures in the form of thin sheets. In this document, the effect of an array of shallow bistable domes formed into a thin metal sheet is described. The bistable domes are capable of being pushed though the plane of the sheet and locked in an inverted position, this deformation being reversible. The author shows that different shape combinations are possible using different arrays and orientations of domes. The structures are made by clamping a thin sheet (0.125 mm) of age-hardened beryllium copper (CuBe) between two thick steel holding plates. Each holding plate has a dense hexagonal array of drilled holes, which line up exactly when the plates are clamped together. A steel rod of the same diameter as a plate hole, is fashioned with a rounded end and is used as a punching tool. Lockable nuts are threaded onto the rod near the same end to preset the punching depth. A hammer or a fly-press can be used to push the rod until the preset depth, and all holes are punched from both sides in a sequential manner, before the holding plates are removed. The dome width is 8.5 mm and the edges of adjacent domes are 2 mm apart.

K. Seffen, in “Mechanical memory metal: A novel material for developing morphing engineering structures” (Scripta Materialia (2006) volume 55, number 4, pp. 411-414, the content of which is herein incorporated by reference in its entirety) describes finite element analysis of arrays of bistable buckling domes. Each dome (or dimple) interacts with other domes, both adjacent and removed, in a complex manner. For a square lattice array of domes in a thin sheet, it is possible to achieve a substantially planar shape for the sheet, but only by ensuring that alternate domes are inverted. Thus, if one of the stable configurations required of a sheet member is flat, then this can only be achieved by pressing alternate domes into the inverted position, which is cumbersome.

The present inventors have realised that it may be possible to form bistable (or, more generally, multistable) structural members that can be adopt one of a number of stable configurations reliably and with only a relatively small intervention force.

In a first preferred aspect, the present invention provides a multistable structural member having a sheet form and having a first configuration in which a first distribution of stored elastic stresses are counterbalanced against at least two reinforcing corrugations and a second configuration in which said corrugations are deformed to provide a second, different distribution of stored elastic stresses counterbalanced by the shape of the member in the second configuration, and wherein said first and second configurations are stable but reversibly interchangeable so that an external force is required to cause a transformation between said first and second configurations.

In this way, the counterbalancing of stored elastic stresses and the shape of the member in each configuration causes each configuration to define a local minimum in terms of energy considerations, thereby making each configuration mechanically stable. The application of an external deformation force to the member in one configuration, particularly if that force is directed towards the shape of the other configuration, will cause the member to transform to the other configuration if the external deformation force is greater than a threshold level.

In a second preferred aspect, the present invention provides a method for forming a multistable structural member, including the steps:
plastically deforming a sheet member to form at least two reinforcing corrugations to reinforce a first configuration,
plastically deforming said sheet member towards a second configuration, thereby elastically deforming said corrugations and causing the formation of a second distribution of elastic stresses in the sheet member, counterbalanced against the second configuration, and, optionally, applying a force to the sheet member in the second configuration to cause it to adopt the first configuration in which a first distribution of stored elastic stresses are counterbalanced against said corrugations.

It will be apparent to the skilled person that the steps of the second aspect may be performed in a different order.

Accordingly, in a third preferred aspect, the present invention provides a method for forming a multistable structural member, including the steps:
plastically deforming a sheet member towards a second configuration,
elastically deforming said sheet member towards a first configuration and then plastically deforming said sheet member to form at least two reinforcing corrugations to reinforce said first configuration, so as to form a first distribution of stored elastic stresses counterbalanced against said corrugations, and, optionally, applying a force to the sheet member in the first configuration to elastically deform said corrugations and cause the formation of a second distribution of elastic stresses in the sheet member, counterbalanced against the second configuration.

Preferred and/or optional features are set out below. These are applicable singly or in any combination with any aspect of the invention, unless the context demands otherwise.

Preferably, the structural member has more than two reinforcing corrugations in the first configuration. For example, there may be three, four, five, six, seven, eight, nine, ten, twelve, fourteen, sixteen, eighteen, twenty or more reinforcing corrugations. The corrugations typically are aligned in the same direction, although it is possible that the corrugations are formed at a small angle to each other and project radially from a locus, e.g. a notional locus located off the structural member. Additionally or alternatively, two or more of the corrugations may overlap. It is preferred, but not essential, that some or all of the corrugations run full length along the sheet member. Where some or all of the corrugations do not run full length along the sheet member, the corrugated section may define a hinging section.

The formation of a corrugation in a sheet material typically results from the plastic deformation of the sheet material out of the original plane of the sheet material, the deformation extending in a longitudinal direction along the sheet. Typically, the corrugation is continuous (although this is not necessarily the case) and extends to the longitudinal ends of the sheet. Multiple corrugations are typically formed side-by side, to provide a “wavelength” to the multiple corrugations. This wavelength (or corrugation spacing) is typically uniform across the corrugations (in a direction transverse to the longitudinal direction) but non-uniform corrugation spacings are also envisaged. Furthermore, the amplitude (depth) of the corrugations is preferably uniform both longitudinally and transversely, but transverse variation in corrugation amplitude is also envisaged.

The formation of a corrugation provides reinforcement of a sheet member against deformation of the sheet tending to bend the sheet around a bending axis non-parallel with the longitudinal extent of the corrugation. This reinforcement principle is well understood, since it provides stiffening support to the sheet out of the original plane of the sheet.

The corrugation may take an angular form in the transverse direction (e.g. a series of sharp peaks and troughs) but is preferably a smooth corrugation, e.g. sinusoidal or near sinusoidal, or semicircular or near-semicircular.

The corrugations may be applied sequentially, so that each corrugation (other than the first) is formed after the previous corrugation in the transverse direction. This is preferred since then each corrugation can be formed carefully, in isolation, and without being affected by simultaneous corrugations elsewhere, since that would otherwise lead to undesirable additional stresses due to lateral stretching of the sheet. Alternately, the corrugations may be applied simultaneously. In this case, the corrugations are formed by extending all of the corrugations longitudinally down the sheet simultaneously, whilst allowing for the transverse shrinkage of the sheet caused by forming the corrugations. This can be done using a transverse array of suitably-shaped rollers. Alternatively, the corrugations can be formed using a longitudinal series of transverse rollers for gradually increasing the corrugation amplitude.

Preferably, the amplitude (i.e. the out-of-plane depth) of the corrugations is controlled so that the corrugations provide sufficient rigidity to the first configuration but so that the corrugations can still be deformed to cause the member to adopt a stable second configuration. The amplitude of the corrugations may be at least 2 times (preferably at least 3 times) the thickness of the sheet member. This is in order that the corrugations provide a suitable reinforcement to the first configuration. The amplitude of the corrugations may be at least 5 times (more preferably at least 10 times) the thickness of the sheet member. In general, as the sheet member area increases, it is desirable also to increase the corrugation amplitude in order to reinforce the first configuration.

As will be understood, the material properties of the sheet member are important in determining the limits of the shapes useable for the first and second configurations. For the transitions between the first and second configuration should occur substantially without permanent plastic deformation, otherwise the product has only at best a limited useful life. Thus, the maximum stresses in the sheet member should not exceed the yield stress of the material. If the corrugations have a radius of curvature of r_{corr}, then the following inequality should be satisfied for the first configuration of the structural member:

$${r}_{corr} > \frac{tE}{2 YS} \qquad ( inequality 1 )$$

Where t is the sheet thickness, E is the elastic modulus and YS is the yield strength.

Similarly, if the second configuration is a rolled configuration, the radius of curvature rᵣₒₗₗ of the rolled shape should satisfy the following inequality:

$${r}_{roll} > \frac{tE}{2 YS} \qquad ( inequality 2 )$$

Thus, if it is desired to form a first configuration with tight corrugations and/or a second configuration with a tightly rolled shape, it is preferred to use a material with a high yield strength and low elastic modulus (i.e. a high yield strain). Additionally, the structural member should be thin, and so typically a hard material is needed (so that it can be strong despite being thin).

Preferably, the stored elastic stress in the first configuration is lower than the yield stress of the material. Furthermore, preferably the stored elastic stress in the second configuration is lower than the yield stress of the material. It is considered that if the radii of curvature according to inequalities 1 and 2 above are satisfied, then the minimum stored elastic stresses required for bistability of the structure are typically lower than the yield stress.

Preferably, the thickness of the sheet member is 2 mm or less, more preferably 1.5 mm or less, 1 mm or less, 0.8 mm or less, 0.6 mm or less. 0.4 mm or less, 0.3 mm or less, or 0.2 mm or less.

It is possible to form preferred structural members at different dimensional scales. For example, micro-scale devices may be preferred. The thickness of the sheet member may be 0.5 mm or less, 0.4 mm or less, 0.3 mm or less, 0.2 mm or less or 0.1 mm or less. For example, the thickness of the sheet member may be 90 μm or less, 80 μm or less, 70 μm or less, 60 μm or less, 50 μm or less, 40 μm or less, 30 μm or less, 20 μm or less or 10 μm or less. In some circumstances, the thickness of the sheet member may be 5 μm or less, 4 μm or less, 3 μm or less, 2 μm or less or even 1 μm or less. In alternative embodiments, the sheet member may be considerably thicker than the ranges set out above, For example, the sheet member may have a thickness in the range 1 to 5 mm.

Preferably, the elastic modulus of the material used for the sheet member is at least 50 GPa, more preferably at least 70 GPa.

Preferably, the yield stress of the material used for the sheet member is at least 400 MPa, more preferably at least 600 MPa.

Preferably, a value for rᵣₒₗₗ achievable for the second configuration is 50 mm or lower. In certain embodiments, values for rᵣₒₗₗ down to 20 mm are possible. In other embodiments (particularly in embodiments utilising thin sheet material), rᵣₒₗₗ may be smaller, e.g. 20 mm or less, 15 mm or less, 10 mm or less, 5 mm or less, 2 mm or less or 1 mm or less. rᵣₒₗₗ may be smaller still for some embodiments, e.g. 800 μm or less, 600 μm or less, 400 μm or less, 200 μm or less, 100 μm or less, 80 μm or less, 60 μm or less, 40 μm or less, 30 μm or less or 20 μm or less.

For some embodiments, rᵣₒₗₗ may be larger than the ranges set out above. For example (particularly for thicker sheet material), rᵣₒₗₗ may be 5 cm or higher, 10 cm or higher, 15 cm or higher or 20 cm or higher.

It is possible that the multistable structural member has a third stable configuration. This may be a similar (though not identical) configuration to the first configuration. However, it is preferred that the multistable structural member has only two stable configurations, so that it is a bistable structural member.

Preferably, the first configuration is a flattened configuration. In this configuration, it is preferred that the corrugations adopt a substantially straight longitudinal shape. For example, the peak of a corrugation in the flattened configuration preferably lies along a substantially straight line. Furthermore, preferably the peaks of the corrugations lie in substantially the same plane as each other. Of course, this plane is not identical to the original plane of the sheet before corrugation. Furthermore, the peaks need not lie in exactly the same plane as each other, since the member may have corrugations of different amplitude in the transverse direction.

Preferably, the second configuration is a tubular configuration. In this configuration, the member is rolled (or partially rolled) around an axis in a different direction to the longitudinal direction of the corrugations of the first configuration. Most preferably, the tubular axis is substantially perpendicular to the longitudinal direction of the corrugations.

There is no particular limit to the number of turns that the second configuration can have. For applications such as the provision of a hinge, less than one turn (e.g. 0.01-0.3 turns, or about a quarter turn or up to a half turn) is preferred. For applications requiring that the second configuration is a storage configuration, there may be one, two, three, four, five or more turns.

During production of the multistable structural member, there may be produced a third configuration. In particular, if the corrugations are produced before deforming the sheet towards the second configuration, the resultant first configuration may have some degree of twist away from the ideal flattened configuration. In that case, there may be a corresponding third configuration that is similar to the first configuration but that has a different (e.g. opposite) sense of twist. Preferably, the production of the structural member includes the additional step of forming again the corrugations, preferably including some amount of plastic deformation. In effect, this involves a pressing or rolling step similar to the original corrugation step, preferably exactly overlying the already-formed corrugations, or increasing the amplitude of the already-formed corrugations. A significant effect of this additional step is that the first configuration can be corrected to the flattened configuration and the third configuration can be removed, leaving a bistable structural element.

Preferably, the sheet is a metallic sheet, e.g. formed from a metallic alloy. Preferred materials are copper-beryllium alloys and steels such as stainless steel or spring steel, although the invention has wider application than this. What is most preferred is a material with a high tensile strength (elastic limit) that, beyond this limit, is highly workable. Also, the material should have a high fatigue resistance and high creep resistance (particularly at room temperature or other operating temperature).

Although the preferred materials are isotropic, it is not necessary that the material be isotropic. For example, a suitable composite sheet structure may be formed by bonding sheets of dissimilar materials and applying corrugations as above. Additionally or alternatively to being formed of dissimilar materials, the bonded sheets may have different, controlled pre-stresses. It is also possible to introduce heterogeneity into the sheet materials, e.g. by etching to produce a thickness variation across the sheet material. The structural member, although allowing reconfiguration between the first and second configurations, is preferably a single-piece sheet.

The structural member may itself form a component part of a larger structure. For example, it may form part of an integral structure having one or more regions of non-multistability. Such a structure may be, for example, sheet panels joined by one or more multistable regions. The activation of the multistable regions between the first and second configurations allows for deployment and storage configurations for the whole structure without the need for complex discrete hinges and other articulation.

It is mentioned here that the reconfiguration between first and second configurations does not depend on crystal phase transformations (as are required to take up reversible shape changes in shape memory alloys and superelastic alloys). Instead, the reconfiguration between these stable shapes requires the creation of stored elastic stresses in the sheet material, balanced against the rigidity provided by the different global shapes of the sheet in the different configurations. For this reason, the present invention has a far wider materials applicability than the specialised shape memory alloys mentioned above, since a suitable material need not demonstrate a crystal phase transformation. Furthermore, it may not be necessary for the residual stresses contained in the material to be provided by conventional mechanical working. It is possible for suitable residual stresses to be stored in the material via other processes.

The present invention has particular applicability to structures and devices that benefit from having a flattened configuration reversibly interchangeable with a tubular (rolled) configuration. For example, the flattened configuration may be for deployment (use) and the tubular configuration may be for storage or transport. One particular application is for flexible displays for computer and/or entertainment devices.

In a fourth preferred aspect, the present invention provides a multistable structural assembly including at least two multistable structural members according to the first aspect.

Preferably, the multistable structural members at least partially overlie each other and are attached to each other at one or more contact points. This attachment may be by any suitable fixing arrangement such as welding, bolting, gluing, etc.

Preferably, the structural assembly has a first configuration that corresponds to the structural members being in their first configurations. Similarly, the structural assembly preferably has a second configuration that corresponds to the structural members being in their second configuration.

In the first configuration of each structural member, preferably the corrugations of the structural members are substantially aligned. In this way, the contact points between the structural members can be arranged to lie along abutting corrugations of adjacent structural members. The attachment of the structural members to each other can be achieved by providing fixing at these contact points or contact lines.

The advantage of using an assembly of structural members in this way is that the stiffness of the assembly can be significantly greater than the stiffness of the individual structural members. It has been found that the rolling of the assembly into the second configuration tends to limit the length of the assembly, since the thickness of the assembly is significantly thicker than that of the individual sheets. Preferably, therefore, the assembly in the first configuration has a width not less than the length of the configuration, the width being measured in a direction parallel with the rolling axis of the second configuration. More preferably, this width is at least 5 times or even at least 10 times the length. In this way, the second configuration of the assembly can have an elongate tubular configuration, which is of interest for load-bearing applications, the first configuration being a storage configuration. It is also possible to store the assembly in the first configuration, but rolled in a direction perpendicular to the direction of rolling of the second configuration. It is preferred that the depth of the assembly, in the first configuration, is at least one quarter of the width, preferably at least one half and most preferably about the same as the width of the assembly in the first configuration.

Preferred embodiments of the invention will now be described, by way of example, with reference to the accompanying drawings, in which:

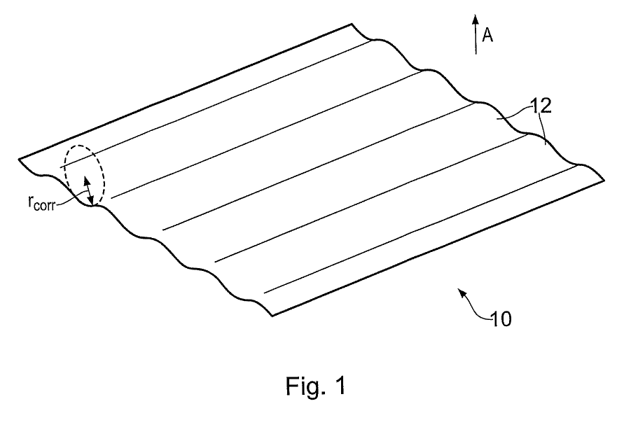

FIG. 1 shows a schematic view of a structural member according to an embodiment of the invention, in a first configuration.

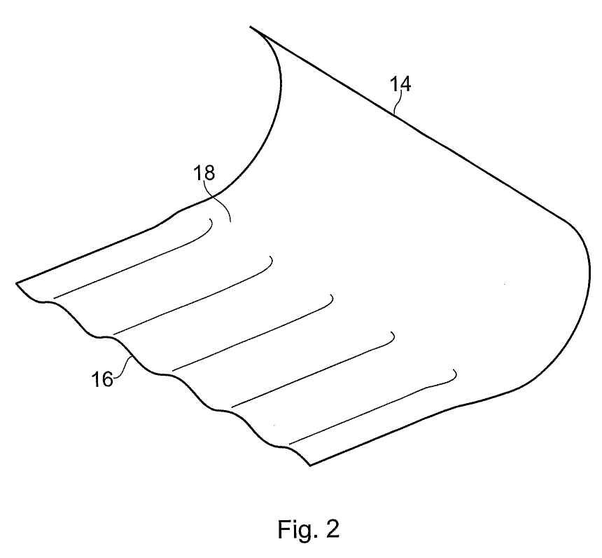

FIG. 2 shows a schematic view of the structural member of FIG. 1 in transition between the first and second configurations.

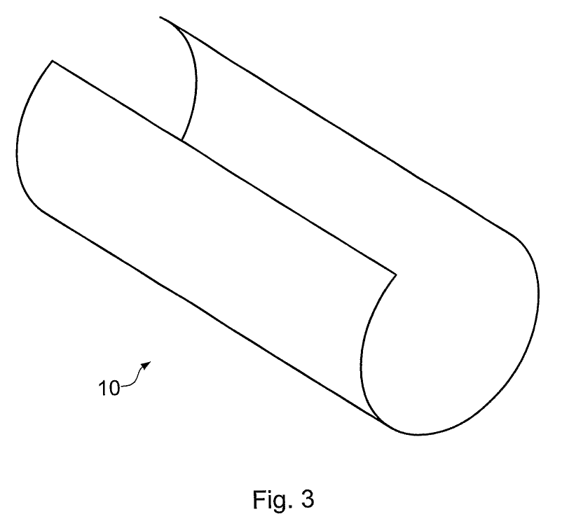

FIG. 3 shows a schematic view of the structural member of FIG. 1 in the second configuration.

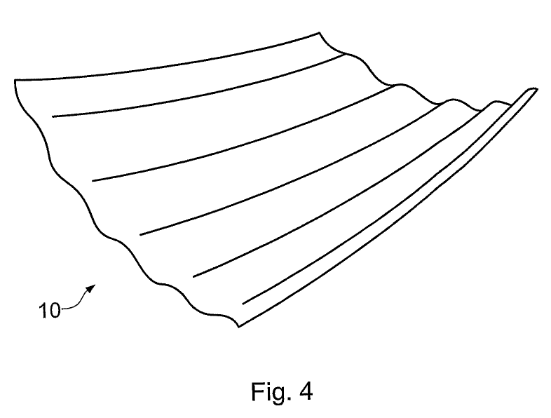

FIG. 4 shows a schematic view of the structural member of FIG. 1 in an optional third configuration.

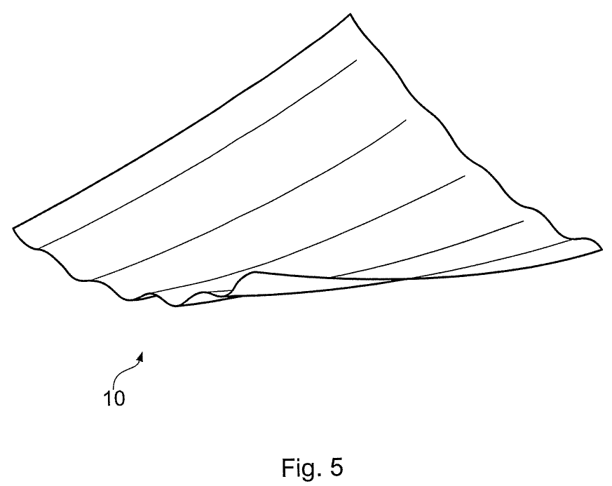

FIG. 5 shows a schematic view of the structural member of FIG. 1 in an optional alternative third configuration.

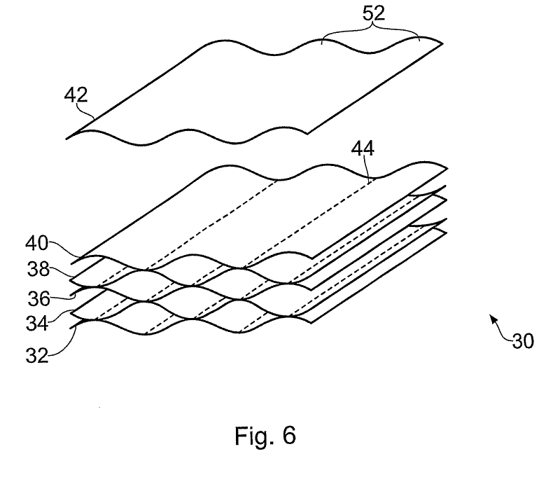

FIG. 6 shows a schematic view of a structural assembly according to an embodiment of the invention.

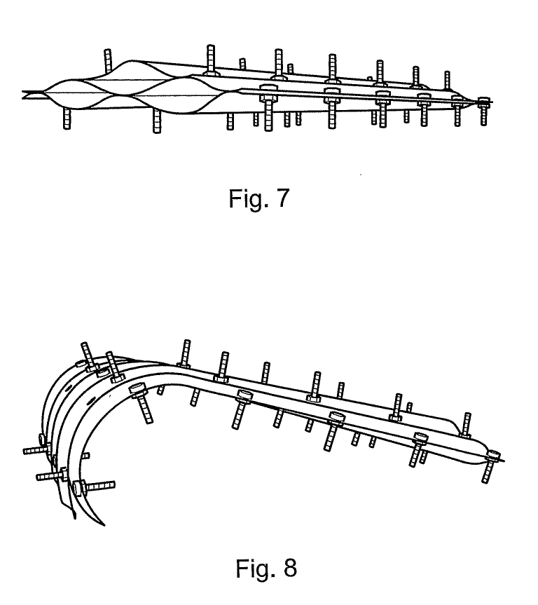

FIGS. 7, 8 and 9 show different views of a prototype structural assembly according to an embodiment of the invention.

FIG. 1 shows a structural member 10 in a first configuration. The structural member 10 has corrugations 12 extending longitudinally. The corrugations extend the full length of the structural member, but it is envisaged that the corrugations could be formed only over part of the length of the member, or could be formed intermittently. Corrugations are also formed across the full transverse width of the structural member.

The first configuration is considered to be a “flattened” configuration, despite the presence of corrugations, since the corrugations themselves are substantially linear, i.e. each has a ridge that follows a substantially straight line. It is preferred, but not essential, that the substantially straight lines associated with each corrugation lie in substantially the same plane. In this way, the first configuration can be used to provide a planar substrate or skeleton to a configurable apparatus such as a display screen.

The structural member is formed by taking a flat sheet of material, typically a metallic material, having materials properties e.g. as set out in the Examples below, and forming each corrugation in the sheet in sequence transversely across the width of the sheet by plastically deforming the sheet (i.e. applying a stress greater than the yield stress). Each corrugation is formed using a simple arrangement of a press having a first ridge tool being received in a correspondingly-shaped valley tool so as to define a single corrugation as a waveform of deformed material, having been deformed in parts of the waveform upwards from the original plane of the sheet material and in other parts of the waveform downwards from the original plane of the sheet material. Schematically, the result of carrying out several such pressing operations transversely in sequence across the width of the sheet is shown in FIG. 1.

In plastically deforming the sheet to form the corrugations, there is some elastic recovery of the material once the pressure of the corrugation press is removed. Nevertheless, significant plastic deformation remains (as shown in FIG. 1). The effect of corrugation is well known, in that the resultant structure has significantly greater stiffness (here resistance to bending in the direction shown by arrow A in FIG. 1) than the original flat sheet of the same material. Much of this increased stiffness is due to the engineering reinforcing effect of the corrugations.

The next stage in the process is to plastically deform the corrugated sheet to the second configuration. Here, the corrugated sheet is deformed by rolling around a mandrel of the desired diameter. This deformation is in response to bending stresses significantly in excess of the increase in stiffness provided by the corrugations. The result is that the structural member takes on a rolled (or partially rolled) configuration that corresponds to the second configuration. Again, after deformation, there will be some elastic recovery of the member. The corrugations disappear in this configuration (although in some cases on close inspection perhaps some remnant of the corrugations will be discernible). However, the result of this deformation is a distribution of complex stored elastic stresses in the member (these are “membrane stresses”) whose precise arrangement depends strongly on the mechanical processing history of the member.

The distribution of stored elastic stresses will be referred to as a second distribution of stored elastic stress. This distribution urges the structure in the second configuration towards the first configuration (flattened corrugated sheet). However, the shape of the structural member in the second configuration provides reinforcement against deformation towards the first configuration. Thus, the structure is stable in the second configuration but can be coaxed into the first configuration by the application of suitable additional stress (e.g. by hand). In this way, the structural member can be opened back into the first configuration, the corrugations reappearing in the member when it is energetically favourable to do so. Once they have reappeared, the corrugations reinforce the structure again. This is necessary, since there is now a first distribution of stored elastic stress (different to the second distribution) that urges the structure back towards the second configuration. This is prevented by the reinforcement provided by the corrugations, but the structure can be rolled back into the second configuration by the application of additional stress (e.g. by hand). In this way, the structure is bistable.

It is found that in many cases, for different materials, the above procedure does not always lead to the flattened corrugated first configuration illustrated in FIG. 1. Instead, a third configuration (illustrated in different “senses” by FIGS. 4 and 5) is formed in which the overall shape of the structural member can be considered to be forming part of a wall of a notional cylinder, but the corrugations not being parallel with the principal axis of the cylinder. In general, the member can be configured between the senses shown in FIGS. 4 and 5 by the application of additional stress. For many applications, such a third configuration is undesirable.

The inventors have found that it is possible reliably to remove the tendency of the structural member to have such a third configuration by, after plastically deforming the member into the second configuration and placing the member back towards the first configuration, carrying out a similar corrugation operation as the first corrugation operation described above, pressing each corrugation again and in the same direction as originally. In effect, this repeats the corrugations formed initially. No additional corrugations are typically formed in this step. The effect of this mechanical processing is to give rise to a small amount of plastic deformation. The result is that the member, in the first configuration, is flattened (as illustrated in FIG. 1) and that the third configuration is not seen. It is considered that the effect of the repeat corrugation step is to fine tune the first distribution of stored elastic stress so that the corrugations balance against the first distribution of stored elastic stress to give a flattened corrugated shape that is stable.

FIG. 2 shows a schematic view of the structural member of FIG. 1 in transition between the first and second configurations. This is caused by an externally-applied stress (e.g. by hand) forcing end 14 of the member towards the local shape of the second configuration. At this part of the member, the combination of the first distribution of stored elastic stress and the additional externally-applied stress is sufficient to overcome the reinforcing effect of the corrugations and the member locally snaps into the second configuration, the corrugations substantially disappearing as shown in FIG. 2, up to a transition region 18 between localised first and second configurations. In some embodiments, the structure shown in FIG. 2 is quasi-stable, in that it is possible to deform the structural member into a shape that is part way between the first and second configurations, and for the member to remain in that shape substantially indefinitely in the absence of externally applied stress. For many embodiments, however, the shape shown in FIG. 2 is merely transitory and the member either returns to the first configuration or snaps fully into the second configuration in the absence of externally applied stress. The behaviour of the member typically depends on the preference of the member for the first configuration over the second configuration (or vice versa), which in turn depends on the first and second distributions of stored elastic stresses and the reinforcing effect of the corrugations and the overall shape of the second configuration. These properties can be tailored by a suitable selection of sheet thickness, corrugation depth, corrugation number and number of turns in the second configuration, starting from the examples set out below.

FIG. 3 shows a schematic view of the member of FIG. 1 in the second configuration. As can be seen, the corrugations are not visible here. In this second configuration, the member has a rolled shape of less than one turn, but more than half a turn.

FIG. 6 shows an schematic partially exploded view of a multistable structural assembly 30 according to an embodiment of the invention. The assembly is formed of five multistable structural members 32, 34, 36, 38, 40. Additional multistable member 42 is illustrated separately for clarity. Each multistable member is, in this embodiment, similar to the multistable member 10 of the first embodiment, in that it is a corrugated sheet having a stable, flattened, first configuration and a stable, rolled, second configuration. Each member has corrugations 52 extending in an elongate direction along the member. In the assembly, the corrugations of adjacent members are arranged to be out of phase so that the upper surface of an upwards corrugation of one member contacts the lower surface of a downwards corrugation. The members are aligned so that lines of contact at the corrugations are formed, illustrated by dashed lines 44 in FIG. 6. At these lines of contact, adjacent members are fixed together. This can be by any suitable fixing means, such as bolting, welding, soldering, brazing, gluing, etc. A fixing arrangement that provides continuous seams of connection (e.g. welding) is preferred for strength. In this way, the assembly has a first configuration in which the members have their first configuration, and a second configuration in which the members have their second configuration. The provision of several members makes at least the first configuration significantly stiffer than the stiffness for each member, since there is a large engineering stiffness contribution from providing material far away from the neutral axis.

It is preferred to use the assembly so that the second, tubular configuration is the deployed configuration and the first configuration is the storage configuration. The assembly may be used, for example, to deploy an antenna (e.g. for spacecraft) or as temporary scaffolding, poles or tubes. FIGS. 7-9 show photographs of a prototype assembly according to an embodiment of the invention. This assembly is formed from three corrugated members, each formed of copper-beryllium alloy as described below. In this prototype, the members are fixed to each other using an array of nuts and bolts, so that the contact points can be seen easily.

In FIG. 7, the assembly is shown held in a hand in the first configuration. The assembly has significant stiffness in this configuration for the reasons explained above.

In FIG. 8, the assembly is shown in transition between the first and second configurations. In the absence of external forces, the assembly can remain in this configuration.

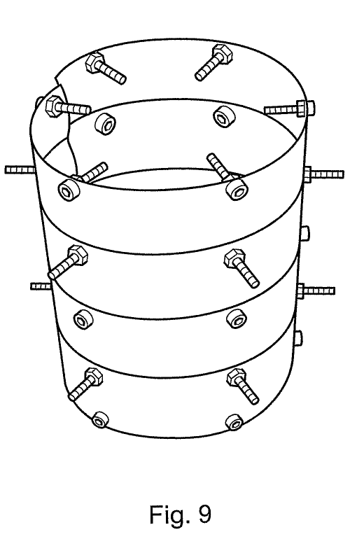

In FIG. 9, the assembly is shown fully in the second configuration.

### EXAMPLE 1

A flat copper-beryllium sheet (1.8-2.0 wt % Be, 0.2 wt % Co+Ni, balance Cu, available as alloy 25 from Brush Wellman, Fairfield, N.J., USA) of thickness 0.125 mm was age hardened at 315° C. for 3 hours. The resultant sheet had a yield strength of around 1200 MPa, an elastic modulus of 130 GPa. Corrugations were formed as set out above with a depth of 2-5 mm and width of 10-20 mm. Next, the sheet was deformed by rolling around a cylindrical mandrel to obtain a rolled second configuration of radius of curvature rᵣₒₗₗ of 7 mm. Next, the member was opened back towards the first configuration and the corrugation step was repeated. The result was a stable flattened first configuration that could readily be transformed into the second configuration and vice versa.

### EXAMPLE 2

A flat shim steel sheet was provided, made to BS 1449 and cold-rolled in hard temper. The composition is 0.12% carbon, 0.6% manganese, 0.05% sulphur and 0.05% phosphorous, remainder iron (all percentages are weight percentages). The sheet thickness was 0.1 mm. Similar steps as described in Example 1 were carried out, except that the second configuration had a rᵣₒₗₗ of 30 mm.

### EXAMPLE 3

A sheet of a typical aluminium alloy used in aircraft structures (alloy 7075) was provided, containing 1.2% copper, 2.1% magnesium, 0.18% chromium, 5.1% zinc, remainder aluminium (all percentages are weight percentages). the sheet was 1 mm thick. To T6 temper, this material has a yield stress of 503 MPa, elastic modulus of 71 GPa. Similar steps as described in Example 1 were carried out, except that the second configuration had a rᵣₒₗₗ of 70 mm.

### EXAMPLE 4

A sheet of titanium alloy Ti-15V-3Cr-3Sn-3Al of thickness 0.31 mm was provided. Annealed, this material had a yield strength of 965 MPa and an elastic modulus of 82 GPa. Similar steps as described in Example 1 were carried out, except that the second configuration had a rᵣₒₗₗ of 13 mm.

### Proposed Applications for Structural Members

It was envisaged, originally, that the primary structural capability derives from the flattened state whilst the curved state expedites compact storage (we refer to this as Mode I). After consideration, it is clear that applications might wish to exploit the reverse feature, that is, the curved state is a primary load-bearing state and the flattened state is secondary (Mode II), or that, indeed, both states are structurally expeditious (Mode III). Furthermore, the functionality may derive from the buckling, self-propelled transition between configurations (Mode IV). Thus, four modes of operation are seen as potentially benefiting applications. The following provisional list of devices aims to highlight areas of usage. This list is non-exhaustive, as will be clear to the skilled person.

### Civil Engineering (Building/Transport Infrastructure)

Blinds (internal) and variable facades (external), for controlling heat and light conditions (Mode III)
External shop awnings (Mode I)
Retractable stadium roofs (Mode III)
Temporary partitions (Mode I)
Exit/escape chutes (Mode I)
Safety hole covers (Mode I)
Temporary vehicular bridges (Mode I)
Extendable loading bays for transport/goods distribution (Mode I)

### Aerospace/Mechanical Engineering

Morphing aero/hydrodynamical surfaces in boats, terrestrial vehicles and aircraft (Mode III)
Deployable solar panel blankets for spacecraft (Mode I)
Convertible car-roofs (Mode III)
Reconfigurable packaging (Mode III)

### Electronic Engineering

Flexible display support for portable media devices (Mode I)
Roll-up QWERTY keyboard and musical synthesiser keyboards (Mode I)

### Multi-Media Support

Portable display/projector/white boards (Mode I)
Collapsible desks/tables/chairs (Mode II)

### Leisure

Personal trekking bridges for outward bound activities (Mode I)
Foldable camping tables (Mode I)
“Carry-mats”—for stiffening the rolled configuration for sleeping (Mode I)
Collapsible surf boards and water lilos (Mode I)
Flexible armour for sportswear integration (Mode III)
Novelty toys (Mode III)
Art installations/kinetic sculptures (Modes I, II, III, IV)

### Bi-Stable Hinges

Bookspline (Mode III)
Spectacle leg hinges (Mode III)

### Rapid-Action Containers

Animal friendly bodily traps (Mode IV)
Suitcases, which fold from flat to cylindrical (Mode II)
Lightweight rubbish containers, as above (Mode II)

### Others

Mechanical fuses, where the snap action mitigates excessive loading (Mode IV)

The above embodiments have been described by way of example. Modifications of these embodiments, further embodiments and modifications thereof will be apparent to the skilled person on reading this disclosure and as such are within the scope of the invention.

1. A multistable structural member having a sheet form and having a first configuration in which a first distribution of stored elastic stresses are counterbalanced against at least two reinforcing corrugations and a second configuration in which said corrugations are deformed to provide a second, different distribution of stored elastic stresses counterbalanced by the shape of the member in the second configuration, and wherein said first and second configurations are stable but reversibly interchangeable so that an external force is required to cause a transformation between said first and second configurations.

2. A multistable structural member according to claim 1 wherein there are at least four reinforcing corrugations arranged transversely across the structural member in the first configuration.

3. A multistable structural member according to claim 1 wherein the corrugations are smooth corrugations.

4. A multistable structural member according to claim 1 wherein the amplitude of the corrugations is controlled so that the corrugations provide sufficient rigidity to the first configuration but so that the corrugations can still be deformed to cause the member to adopt a stable second configuration.

5. A multistable structural member according to claim 1 wherein the first configuration is a flattened configuration in which the corrugations optionally adopt a substantially straight longitudinal shape, the peaks of the corrugations optionally lying in substantially the same plane as each other.

6. A multistable structural member according to claim 1 wherein the second configuration is a tubular or rolled configuration.

7. A multistable structural member according to claim 1 wherein the sheet is a metallic sheet.

8. A multistable structure having one or more regions of monostability and one or more, optionally integral, multistable structural members according to claim 1.

9. A multistable structure member according to claim 8 wherein said one or more regions of monostability include sheet panels.

10. A multistable structure according to claim 8 wherein said one or more multistable structural members act as hinges, optionally bistable hinges.

11. (canceled)

12. A method for forming a multistable structural member, including either the steps:
plastically deforming a sheet member to form at least two reinforcing corrugations to reinforce a first configuration,
plastically deforming said sheet member towards a second configuration, thereby elastically deforming said corrugations and causing the formation of a second distribution of elastic stresses in the sheet member, counterbalanced against the second configuration, and,
optionally, applying a force to the sheet member in the second configuration to cause it to adopt the first configuration in which a first distribution of stored elastic stresses are counterbalanced against said corrugations,
or the steps:
plastically deforming a sheet member towards a second configuration,
elastically deforming said sheet member towards a first configuration and then plastically deforming said sheet member to form at least two reinforcing corrugations to reinforce said first configuration, so as to form a first distribution of stored elastic stresses counterbalanced against said corrugations, and,
optionally, applying a force to the sheet member in the first configuration to elastically deform said corrugations and cause the formation of a second distribution of elastic stresses in the sheet member, counterbalanced against the second configuration.

13. A method according to claim 12 wherein the corrugations are applied sequentially.

14. A method according to claim 12 wherein the corrugations are applied by plastically deforming the sheet into corrugations simultaneously gradually along the longitudinal extent of the corrugations.

15. A method according to claim 12 further including, after returning the member to the first configuration from the second configuration, the additional step of forming again the corrugations, optionally by applying a non-zero amount of plastic deformation to the sheet.

16. (canceled)

17. (canceled)
